(19) United States
(12) Patent Application Publication
(10) Pub. No.: US 2026/0349203 A1
(43) Pub. Date: Nov. 5, 2026

(54) DETACHABLE LASER TRANSMISSION MODULE AND OPTICAL CONNECTOR ASSEMBLY FOR IC INTEGRATION

(71) Applicant: AIP Inc., New Taipei City (TW)

(72) Inventor: Chia LEE, New Taipei City (TW)

(21) Appl. No.: 19/267,786

(22) Filed: Jul. 14, 2025

Related U.S. Application Data
(60) Provisional application No. 63/797,359, filed on Apr. 30, 2025.

(51) Int. Cl. G02B 6/42

(52) U.S. Cl. CPC G02B 6/4292; G02B 6/4225; G02B 6/4249

(57) ABSTRACT

An optical connector assembly for IC integration and a detachable laser transmission module are provided. The optical connector assembly for IC integration includes an integrated circuit module and a detachable laser transmission module. The integrated circuit module includes an integrated circuit. The detachable laser transmission module is configured to optically couple to the integrated circuit module, and includes a laser fixed element configured to be secured to the integrated circuit module and a laser detachable connector detachably engaged with the laser fixed element and holding a laser unit.

### CROSS REFERENCE TO RELATED APPLICATIONS

This application claims the benefit of U.S. Provisional Patent Application No. 63/797,359, filed on Apr. 30, 2025, the entire content of which is incorporated by reference herein.

### FIELD OF DISCLOSURE

The present application relates to optical connectors, and more particularly to a detachable laser transmission module and an optical connector assembly for IC integration, configured to enable array-level optical coupling with photonic integrated circuits or optoelectronic integrated circuits and allow external positioning of a laser array relative to the IC for optical connection.

### BACKGROUND

Photonic integrated circuits (PICs) are essential components in optical communication systems by integrating multiple optical functions into a single chip.

Conventional optical coupling processes for aligning multiple optical fibers or laser sources to a PIC often rely on manual alignment techniques. These techniques are labor-intensive and time-consuming, as each fiber or laser source must be individually positioned and coupled to a corresponding optical port or interface on the PIC.

Consequently, conventional optical coupling processes are difficult to scale for high-throughput manufacturing, resulting in limited precision and driving up assembly costs. Therefore, there is an urgent need in the art for a solution that addresses the limitations of manual alignment and enables efficient and repeatable assembly.

Additionally, in a conventional design of the PIC, the laser source is directly integrated within the PIC to ensure precise optical coupling between the laser source and the optical connection port or the optical interface on the PIC and to reduce alignment complexity and optical loss. However, this internal integration introduces several issues, for example, the fabrication of the PIC with the embedded laser source tends to result in poor yield due to stringent process requirements, and heat generated by the embedded laser source may affect nearby electronic components and degrade the overall performance and reliability of the PIC.

### SUMMARY OF DISCLOSURE

The present application provides a detachable laser transmission module and an optical connector assembly for IC integration, configured to address issues associated with the prior art related to alignment complexity, thermal interference, and integration yield. The optical connector assembly enables array-level coupling of optical fibers and/or laser sources to photonic or optoelectronic integrated circuits (PICs or OEICs).

The optical connector assembly disclosed herein includes detachable alignment components configured for high-precision positioning between optical waveguides and a laser array. Batch-level coupling and improved optical alignment precision are achieved by active alignment of optical waveguide with a one-piece laser array fabricated by semiconductor manufacturing methods such as epitaxial growth or lithographic, ensuring compatibility with wafer-level processes and supporting mass manufacturing. The active alignment between the optical waveguides and the laser array enables sub-micron coupling precision, enhances optical performance, and reduces insertion loss.

Additionally, in the configuration of the present application, the laser array is externally positioned relative to the PIC or the OEIC, and optically coupled to the PIC or the OEIC via the optical connector assembly. This external arrangement decouples the thermal sources from the PIC or the OEIC, prevents localized heating, and allows independent thermal management of the laser array. Such separation also facilitates flexible system layout and reduces process complexity by eliminating co-packaging constraints.

In a first aspect, the present application provides an optical connector assembly for IC integration. The optical connector assembly includes an integrated circuit module and a detachable laser transmission module.

The integrated circuit module includes an integrated circuit. The detachable laser transmission module is configured to optically couple to the integrated circuit module.

Optionally, in one embodiment of the present application, the detachable laser transmission module includes a laser fixed element and a laser detachable connector. The laser fixed element is configured to be secured to the integrated circuit module. The laser detachable connector is detachably engaged with the laser fixed element and configured to hold a laser unit.

Optionally, in one embodiment of the present application, the laser unit includes a substrate and a laser array formed along an edge of the substrate. The laser array is composed of a plurality of laser emitters to form a one-piece laser array.

Optionally, in one embodiment of the present application, the detachable laser transmission module further includes a guiding element positioned in the laser fixed element. The guiding element is configured to be fixed in the laser fixed element after active alignment with the laser unit.

Optionally, in one embodiment of the present application, the laser fixed element is configured to be secured to the integrated circuit module after the guiding element, the laser unit, and the integrated circuit are actively aligned with one another.

Optionally, in one embodiment of the present application, the laser fixed element includes a fixed housing, an installation slot and least one mating portion. The fixed housing is disposed adjacent to the integrated circuit module. The installation slot is recessed in the fixed housing and configured to accommodate the guiding element.

The laser detachable connector includes a main body and at least one positioning portion detachably engaged with the mating portion.

Optionally, in one embodiment of the present application, the integrated circuit module further includes a first optical interface disposed on a side of the integrated circuit. At least one internal feedback loop is formed between the guiding element and the first optical interface upon engagement of the detachable laser transmission module and the integrated circuit module, and the at least one internal feedback loop is configured to receive an optical signal emitted from the laser unit.

Optionally, in one embodiment of the present application, the detachable laser transmission module includes two guiding elements configured to mutually align with each other. One of the two guiding elements is positioned within the laser fixed element, and the other one of the two guiding elements is positioned at the laser detachable connector and optically aligned to the laser unit.

Optionally, in one embodiment of the present application, the integrated circuit module further includes a first optical interface and a second optical interface disposed on a side of the integrated circuit. The detachable laser transmission module is configured to optically couple to the first optical interface.

Optionally, in one embodiment of the present application, the optical connector assembly for IC integration further includes a fiber transmission module configured to optically couple to the integrated circuit module. The fiber transmission module includes a fiber part, a fiber fixed element and a cover. The fiber fixed element is secured to the integrated circuit module. The cover is configured to hold and secure the fiber part to the fiber fixed element.

The fiber part includes multiple optical fibers housed between the fiber fixed element and the cover and optically coupled to the second optical interface.

Optionally, in one embodiment of the present application, the optical connector assembly for IC integration further includes a fiber transmission module configured to optically couple to the integrated circuit module. The fiber transmission module includes a fiber part, a fiber fixed element and a fiber detachable connector. The fiber fixed element is secured to the integrated circuit module and includes at least one mating portion. The fiber detachable connector is detachably engaged with the fiber fixed element and included at least one positioning portion respectively corresponding to and configured to engage with the mating portion.

The fiber part includes multiple optical fibers being held by the fiber detachable connector and optically coupled to the second optical interface.

In a second aspect, the present application provides a detachable laser transmission module configured to optically couple to an integrated circuit module and including a laser fixed element and a laser detachable connector.

The laser fixed element is configured to be secured to the integrated circuit module. The laser detachable connector is detachably engaged with the laser fixed element and configured to hold a laser unit.

Optionally, in one embodiment of the present application, the laser unit includes a substrate and a laser array formed along an edge of the substrate. The laser array is composed of a plurality of laser emitters to form a one-piece laser array.

Optionally, in one embodiment of the present application, the detachable laser transmission module further includes a guiding element positioned in the laser fixed element. The guiding element is configured to be fixed in the laser fixed element after active alignment with the laser unit.

Optionally, in one embodiment of the present application, the laser fixed element is configured to be secured to the integrated circuit module after the guiding element, the laser unit, and the integrated circuit module are actively aligned with one another.

Optionally, in one embodiment of the present application, the laser fixed element includes a fixed housing, an installation slot and at least one mating portion. The fixed housing is disposed adjacent to the integrated circuit module. The installation slot is recessed in the fixed housing and configured to accommodate the guiding element.

The laser detachable connector includes a main body and at least one positioning portion detachably engaged with the mating portion.

Optionally, in one embodiment of the present application, the integrated circuit module includes an integrated circuit and a first optical interface disposed on a side of the integrated circuit. At least one internal feedback loop is formed between the guiding element and the first optical interface upon engagement of the laser transmission module and the integrated circuit module, and the at least one internal feedback loop is configured to receive an optical signal emitted from the laser unit.

Optionally, in one embodiment of the present application, the detachable laser transmission module further includes two guiding elements configured to mutually align with each other. One of the two guiding elements is positioned within the laser fixed element. The other one of the two guiding elements is positioned at the laser detachable connector and optically aligned to the laser unit.

The present application offers the following beneficial effects: An active alignment process is performed between the laser array and the integrated circuit module prior to engagement, enabling array-level coupling and sub-micron optical alignment precision. This configuration reduces labor costs and insertion loss and enhances optical performance. This configuration also enables reusability by allowing an alternative laser device to align with the first optical interface of the integrated circuit module through respective active alignment processes. In addition, since the laser array a one-piece array and externally positioned from the integrated circuit module, thermal interference with the integrated circuit module is minimized, and integration flexibility and fabrication yield are improved. This arrangement further facilitates compatibility with semiconductor manufacturing workflows.

### BRIEF DESCRIPTION OF DRAWINGS

The accompanying drawings briefly illustrate various embodiments of the present application and are provided to facilitate understanding of the disclosed technical solutions. These drawings depict only example embodiments and do not limit the scope of the present application.

FIG. 1 is a perspective view of an optical connector assembly for IC integration, shown in a disengaged state, in accordance with a first embodiment of the present application.

FIG. 2 is an exploded view of the optical connector assembly according to the first embodiment of the present application.

FIG. 3 is a perspective view of the optical connector assembly in an engaged state, according to the first embodiment of the present application.

FIG. 4 is a schematic diagram illustrating an engagement between the detachable laser transmission module and an integrated circuit module according to one embodiment of the present application.

FIG. 5 is a partially enlarged perspective view of a detachable laser transmission module of the optical connector assembly for IC integration shown in a disengaged state according to a second embodiment of the present application.

FIG. 6 is a perspective view of the optical connector assembly for IC integration shown in a disengaged state according to a third embodiment of the present application.

FIG. 7 is a perspective view of the optical connector assembly for IC integration shown in an engaged state according to the third embodiment of the present application.

FIG. 8 is a perspective view of an optical connector assembly for IC integration shown in a disengaged state according to a fourth embodiment of the present application.

### DETAILED DESCRIPTION

Exemplary embodiments will now be described in detail with reference to the accompanying drawings. These embodiments may be implemented in various forms and are not intended to limit the present application. The descriptions are provided to facilitate understanding of the disclosed concepts by those skilled in the art.

The present application provides an optical connector assembly for IC integration. The assembly enables simultaneous alignment and coupling of all optical fibers and/or laser arrays to a PIC or OEIC and includes a detachable structure suitable for repeated use. This design overcomes the limitations of conventional one-by-one alignment methods and supports scalable manufacturing and efficient assembly. By externally positioning the laser array formed through semiconductor processes, the optical connector assembly maintains high optical coupling precision between the PIC or OEIC and the laser array while also addressing thermal management challenges associated with heat-generating laser structures.

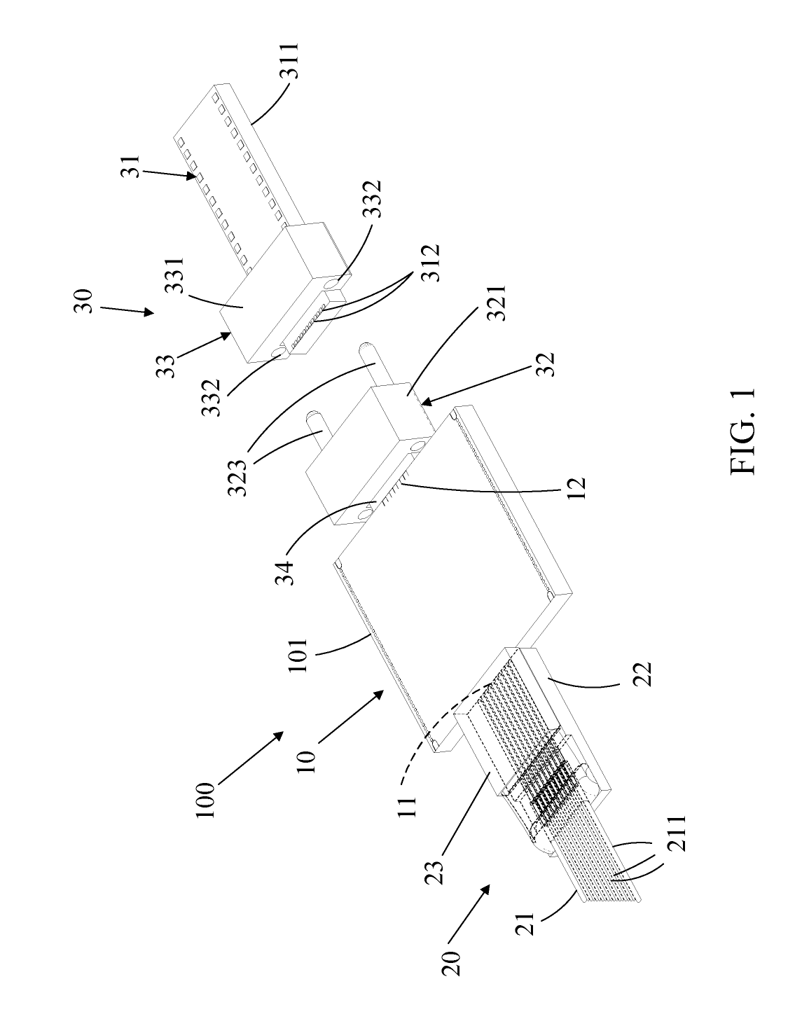

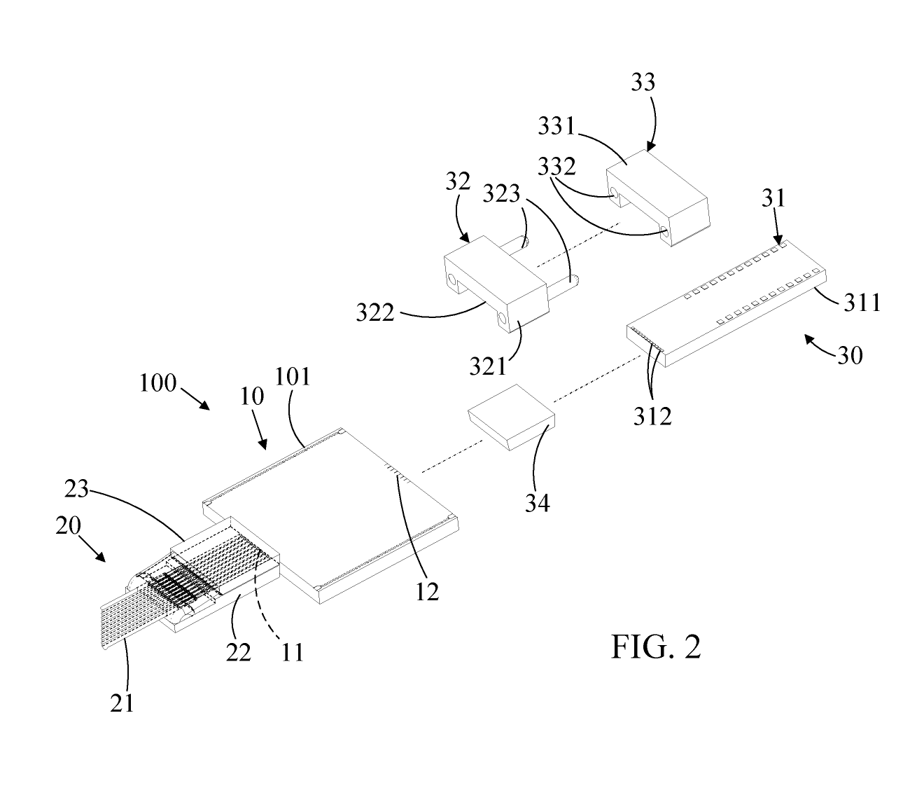

Referring to FIGS. 1 and 2, FIG. 1 illustrates a perspective view of an optical connector assembly 100 for IC integration according to a first embodiment of the present application. The optical connector assembly 100 includes an integrated circuit (IC) module 10, and a detachable laser transmission module 30.

The integrated circuit module 10 may be implemented as a photonic integrated circuit (PIC) or an optoelectronic integrated circuit (OEIC), and includes an integrated circuit 101 and a first optical interface 12 to form a co-packaged optics (CPO). The first optical interface 12 is formed on a side of the integrated circuit 101. The first optical interface 12 is configured to optically couple to the detachable laser transmission module 30, and may include an edge coupler, a spot-size converter, a grating coupler, an adiabatic taper, or a combination thereof.

It should be noted that the internal operation of the integrated circuit module 10 is consistent with known semiconductor technologies, and a detailed description thereof is omitted herein for brevity.

The detachable laser transmission module 30 is configured for optical coupling to the first optical interface 12, and includes a laser fixed element 32, a laser detachable connector 33, and a guiding element 34.

The laser fixed element 32 is configured to be secured to the integrated circuit module 10 and includes a fixed housing 321, an installation slot 322, and at least one mating portion 323. The fixed housing 321 is disposed adjacent to the first optical interface 12. The installation slot 322 is recessed in the fixed housing 321 and configured to accommodate the guiding element 34. The laser detachable connector 33 is detachably engaged with the laser fixed element 32 and configured to hold a laser unit 31. The laser detachable connector 33 includes a main body 331 and at least one positioning portion 332 detachably engaged with the mating portion 323. The guiding element 34, which may be an optical waveguide, is positioned in the installation slot 322 of the laser fixed element 32.

Specifically, the guiding element 34 is configured to be fixed in the laser fixed element 32 after active alignment with the laser unit 31. The laser fixed element 32 is configured to be secured to the integrated circuit module 10 after the guiding element 34, the laser unit 31, and the integrated circuit 101 are actively aligned with one another.

It should be noted that different assembly approaches may be adopted to implement the active alignment process. In some embodiments, the laser unit 31 and the guiding element 34 are actively aligned and temporarily fixed in position using a fixture. After engagement between the laser fixed element 32 and the laser detachable connector 33, the laser unit 31 and the guiding element 34 are respectively bonded or soldered to the laser detachable connector 33 and the laser fixed element 32. In another embodiment, the laser unit 31 is first bonded or soldered to the laser detachable connector 33. The laser detachable connector 33 is then engaged with the laser fixed element 32, followed by active alignment between the laser unit 31 and the guiding element 34. The guiding element 34 is then bonded or soldered to the laser fixed element 32. In yet another embodiment, the guiding element 34 is first bonded or soldered to the laser fixed element 32. After engagement between the laser detachable connector 33 and the laser fixed element 32, the laser unit 31 is positioned on the laser detachable connector 33 and actively aligned with the guiding element 34. The laser unit 31 is then bonded or soldered to the laser detachable connector 33.

In some embodiments, the guiding element 34 is formed using epitaxial growth and etching-based methods.

In some embodiments, the laser fixed element 32 includes multiple mating portions 323 formed on the fixed housing 321, and the laser detachable connector 33 includes multiple positioning portions 332 respectively corresponding to and configured to engage with the mating portions 323.

In the first embodiment, as shown in FIGS. 1 and 2, the laser fixed element 32 includes two mating portions 323 formed as insertion pins extending from the fixed housing 321. The laser detachable connector 33 includes two positioning portions 332 shaped as holes corresponding to the two mating portions 323.

The laser unit 31 includes a substrate 311 and a laser array 312 formed along an edge of the substrate 311. The laser array 312 is configured to be optically aligned with the first optical interface 12 and composed of multiple laser emitters to form a one-piece laser array.

In the first embodiment, the multiple laser emitters may be laser diodes made of semiconductor materials including, but not limited to, gallium arsenide (GaAs), gallium nitride (GaN), or indium gallium arsenide phosphide (InGaAsP), and include epitaxial light-emitting structures.

In some embodiments, the fabrication process for the laser array 312 involves following steps: preparing a growth substrate, such as sapphire substrate, silicon substrate, GaN substrate, GaAs substrate, or the like; optionally forming an epitaxial layer on the substrate via metal-organic chemical vapor deposition (MOCVD); forming an epitaxial light-emitting structure on the epitaxial layer, including an n-type epitaxial layer disposed on the epitaxial layer and a p-type epitaxial stack disposed on the n-type epitaxial layer; etching a portion of the p-type epitaxial stack to expose the n-type epitaxial layer and to form multiple laser emitters spaced apart from each other; and forming a plurality of electrodes respectively disposed on the p-type epitaxial stack and the exposed n-type epitaxial layer to enable external electrical connection.

Using epitaxial and etching-based method, the position and design of the laser unit 31 can be precisely controlled, facilitating high-density integration and miniaturization. In addition, in the field of optical fiber transmission, an output power of the laser is sufficient to suppress the effect of optical divergence. The one-piece-form laser array 312 is well-suited for coupling with optical fibers. Furthermore, because both the guiding element 34 and the laser array 312 are produced by epitaxial and etching-based methods, an alignment between the guiding element 34 and the laser array 312 can be improved, thereby reducing alignment tolerance requirements during assembly and enhancing overall optical coupling efficiency. In addition, since the fabrication of the laser array 312 is performed outside the integrated circuit module 10, the thermal budget applied to the integrated circuit module is reduced, which helps preserve the performance of temperature-sensitive components and simplifies the backend integration process. As a result, the overall manufacturing process becomes more flexible, and the production yield of the integrated circuit module 10 is improved.

It should be understood that the fabrication process for the laser array 312 described above is provided for illustrative purposes only and is not intended to limit the scope of the present application. The specific process steps and sequences may be modified based on actual requirements, and detailed operational parameters are well known to those skilled in the art and are therefore omitted herein.

Referring again to FIG. 1, when the optical connector assembly 100 is in a disengaged state before engagement between the integrated circuit module 10 and the detachable laser transmission module 30, the laser unit 31 is first fixed within the laser detachable connector 33. Then the laser fixed element 32 is engaged with the laser detachable connector 33. The guiding element 34 is positioned within the fixed housing 321 through an active aligned process before being secured to the installation slot 322. Once the guiding element 34 is actively aligned with the laser unit 31, the assembled laser fixed element 32 and the laser detachable connector 33 are positioned to align with coupler ports formed within the first optical interface 12. After the guiding element 34, the laser unit 31, and the first optical interface 12 are actively aligned with one another, the fixed housing 321 is secured to the integrated circuit module 10. Once the fixed housing 321 is secured to the integrated circuit module 10, the laser fixed element 32 and the laser detachable connector 33 can be repeatedly detached and re-engaged without requiring a realignment process.

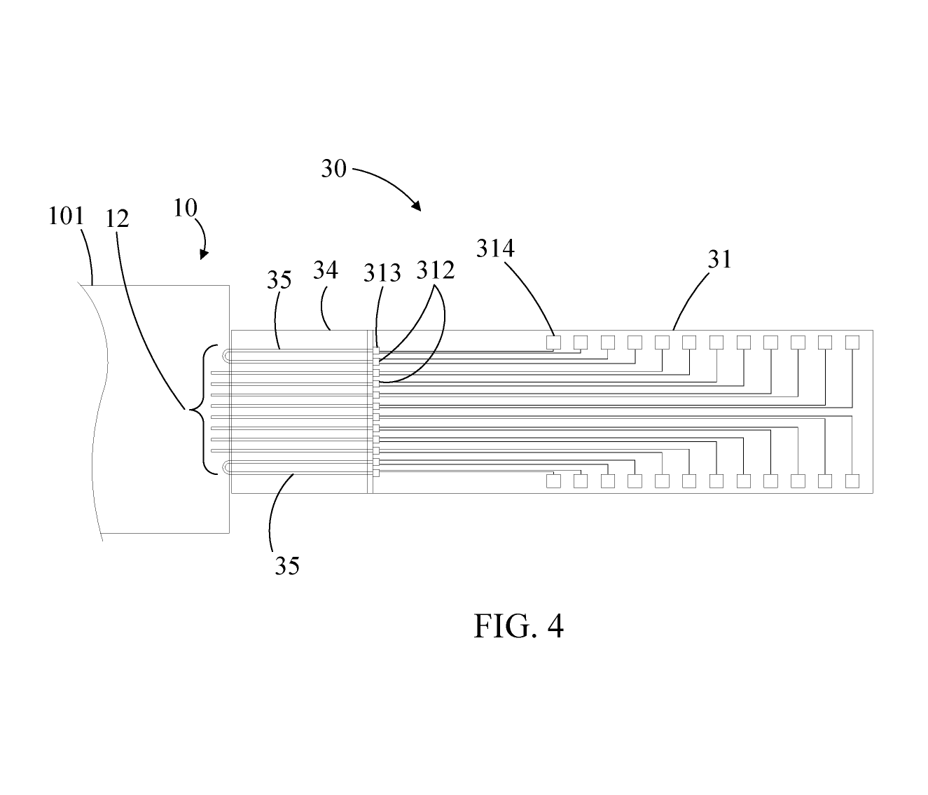

Referring to FIG. 4, in one embodiment, upon engagement between the detachable laser transmission module 30 and the integrated circuit module 10, two internal feedback loops 35 are formed between the guiding element 34 and the first optical interface 12 to confirm optical signal integrity from the laser array 312 of the laser unit 31 and to ensure optical alignment accuracy during the active alignment process. An optical signal emitted from the laser array 312 is input into one of the internal feedback loops 35. A feedback signal returning along the return path of the internal feedback loop 35 is monitored by a photodiode 313, which converts the optical signal into an electrical signal and outputs it to electrodes 314. The photodiode 313 may be disposed within the laser unit 31 or integrated with the laser array 312 for monitoring optical feedback signals. The electrodes 314 are electrically connected to the photodiode 313 to transmit the converted electrical signals for further processing or alignment control.

This feedback mechanism enables real-time optical alignment optimization by detecting misalignment-induced power fluctuations and dynamically adjusting the positioning of the laser unit.

In other embodiments, one or more internal feedback loops 35 may be implemented depending on design requirements, system complexity, or alignment accuracy demands.

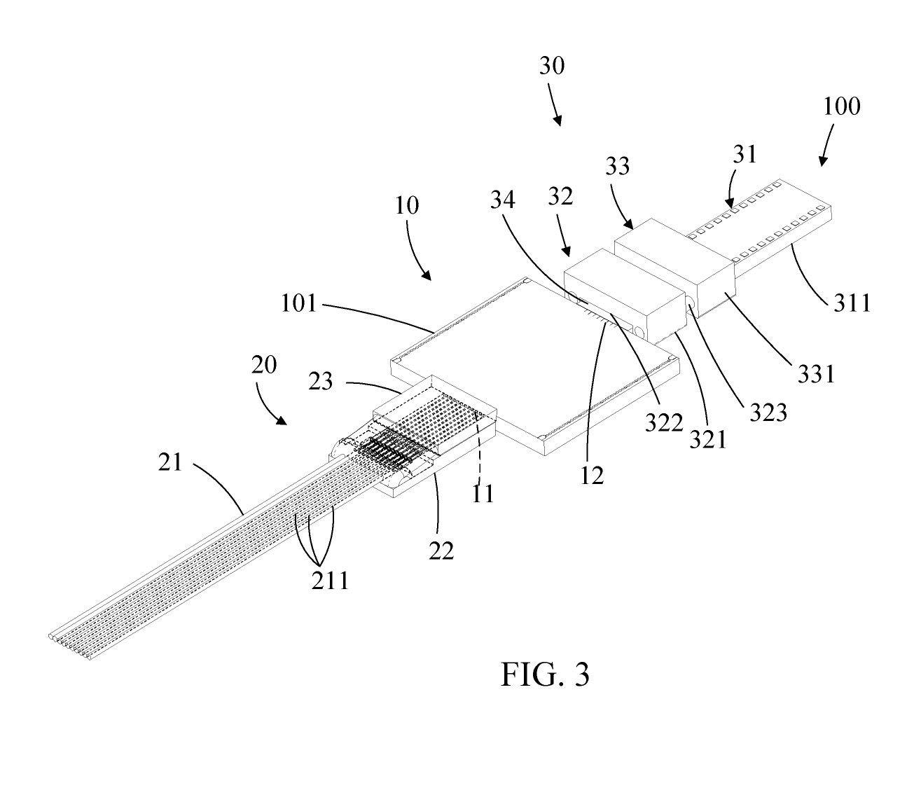

Referring to FIG. 3, FIG. 3 illustrates the optical connector assembly 100 in an engaged state according to the first embodiment. After the first optical interface 12, the guiding element 34, and the laser unit 31 are actively aligned with each other, the fixed housing 321 is secured to the integrated circuit module 10. When the laser detachable connector 33 is disengaged and then re-engaged with the laser fixed element 32, the two mating portions 323 (i.e., insertion pins) are inserted into corresponding positioning portions 332 (i.e., holes). This allows the laser array 312 to be optically aligned with the first optical interface 12 without additional alignment. As a result, simultaneous multi-channel coupling and light signal transmission are achieved between the laser emitters and the optical couplers formed within the first optical interface 12. A light emitted from the laser array 312 passes through the guiding element 34 and is then coupled into the first optical interface 12, enabling efficient optical coupling between the laser array 312 and the integrated circuit module 10.

After the optical connector assembly 100 has been used, the laser detachable connector 33 can be disengaged from the laser fixed element 32. The first optical interface 12 of the integrated circuit module 10 remains available for subsequent active alignment with another laser array. This reusability is achieved by equipping an alternative laser device with a corresponding alternative laser detachable connector 33. The alternative laser detachable connector 33 is first engaged with the laser fixed element 32 to ensure proper alignment with the first optical interface 12 through an active alignment process, and is then secured to form an alternative detachable laser transmission module 30. The detachable laser transmission module 30 provided in the present application not only improves ease of use but also significantly reduces labor costs associated with individual optical alignment during replacement or reconfiguration. Additionally, since the laser unit 31 is externally disposed from the integrated circuit module 10, heat generated by the laser array 312 is dissipated directly to the outside, thereby preventing thermal interference with other components within the integrated circuit module 10.

In some embodiments, the first optical interface 12 of the integrated circuit module 10 remains available for subsequent engaging with another laser array. This reusability is achieved by providing an alternative detachable laser transmission module 30 through the following steps.

First, an original guiding element 34 is aligned with an original laser array 312 by an active alignment process and fixed in the fixed housing 321, while an original laser detachable connector 33 is engaged with an original laser fixed element 32. Subsequently, the original laser detachable connector 33 is disengaged from the original laser fixed element 32. An alternative laser detachable connector 33 is then engaged with the original laser fixed element 32, and an alternative laser unit 31 is secured with the alternative laser detachable connector 33 after the alternative laser array is actively aligned with the original guiding element 34. Thereafter, the original laser fixed element 32 is detached from the alternative laser detachable connector 33, and an alternative laser fixed element, together with an alternative guiding element 34, is provided to engage and align with the alternative laser detachable connector 33 to form an alternative detachable laser transmission module 30. A plurality of alternative detachable laser transmission module 30 having properly aligned laser fixed elements 32 and laser detachable connectors 33 can be provided in this manner.

It should be noted that these embodiments described above illustrate different modular replacement strategies, providing greater flexibility in optical design or adaptation to different laser unit 31. Depending on the replacement strategy adopted, the guiding element 34 may remain fixed to allow repeated replacement of the laser detachable connector 33 without requiring realignment, or both the guiding element 34 and the laser fixed element 32 may be replaced together with the laser unit 31.

Optionally, in some embodiments, an active alignment process may be performed prior to securing the alternative laser fixed element 32 to the first optical interface 12. During this process, the guiding element 34 positioned within the alternative laser fixed element 32 is actively aligned with the first optical interface 12, followed by subsequent assembly steps. This configuration enables the use of multiple alternative detachable laser transmission modules 30, each having a properly aligned combination of a laser array 312 and a guiding element 34, to achieve optical alignment with the first optical interface 12.

Referring to FIGS. 1 and 2 again, in other embodiments, the optical connector assembly 100 further includes a fiber transmission module 20 configured to optically couple to the integrated circuit module 10. The integrated circuit module 10 includes the first optical interface 12 and a second optical interface 11 disposed on sides of the integrated circuit 101 to form a co-packaged optics (CPO).

In this embodiment, the first optical interface 12 and a second optical interface 11 are respectively formed on opposite sides of the integrated circuit 101.

Notably, this configuration does not serve as a limitation. In other embodiments, the first optical interface 12 and the second optical interface 11 may also be disposed on the same side or on adjacent sides of the integrated circuit 101. The second optical interface 11 is configured to optically couple to the fiber transmission module 20, and may include an edge coupler, a grating coupler, a spot-size converter, or a combination thereof.

The fiber transmission module 20 is, for example a fiber array unit (FAU), configured for optical fiber coupling to the integrated circuit module 10 and includes a fiber part 21, a fiber fixed element 22 and a cover 23. The fiber part 21 includes multiple optical fibers 211. The fiber fixed element 22 is secured to the integrated circuit module 10 and positioned adjacent to the second optical interface 11. The cover 23 is configured to hold and secure the fiber part 21 to the fiber fixed element 22. The optical fibers 211 are housed between the fiber fixed element 22 and the cover 23 and optically coupled to respective coupler ports formed within the second optical interface 11.

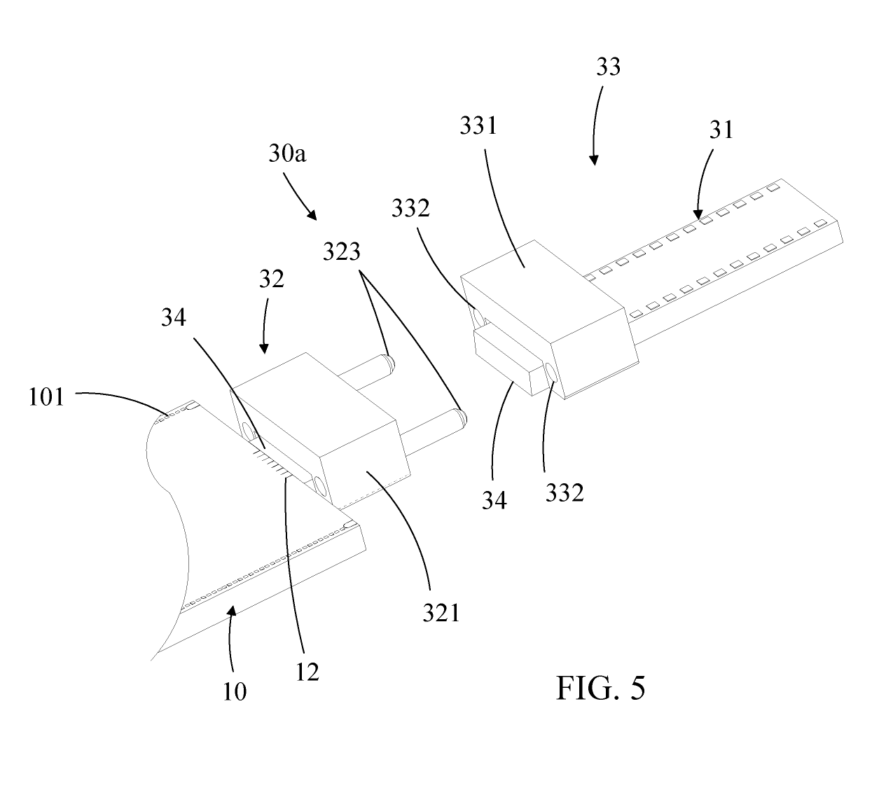

Referring to FIG. 5, FIG. 5 illustrates a detachable laser transmission module 30a of the optical connector assembly 100 for IC integration according to a second embodiment of the present application.

In the second embodiment, the detachable laser transmission module 30a includes two guiding elements 34. The two guiding elements 34 may be optical waveguides configured to mutually align with each other, enabling optical signals to be transmitted through their coupled interfaces during engagement. One of the two guiding elements 34 is positioned within the installation slot 322 and optically aligned with the first optical interface 12, while the other one of the two guiding elements 34 is positioned at the main body 331 of the laser detachable connector 33 and optically aligned with the laser array 312.

When the optical connector assembly 100 is in an engaged state, the detachable laser transmission module 30a is engaged with the optical connector assembly 10, and the two guiding elements 34 form an optically aligned interface, allowing the laser array 312 to be optically aligned and coupled with the optical couplers formed within the first optical interface 12. Additionally, the arrangement of the two guiding elements 34 facilitates precise optical coupling, thereby enhancing alignment accuracy, reducing optical loss, and improving signal transmission efficiency across the optically aligned interface.

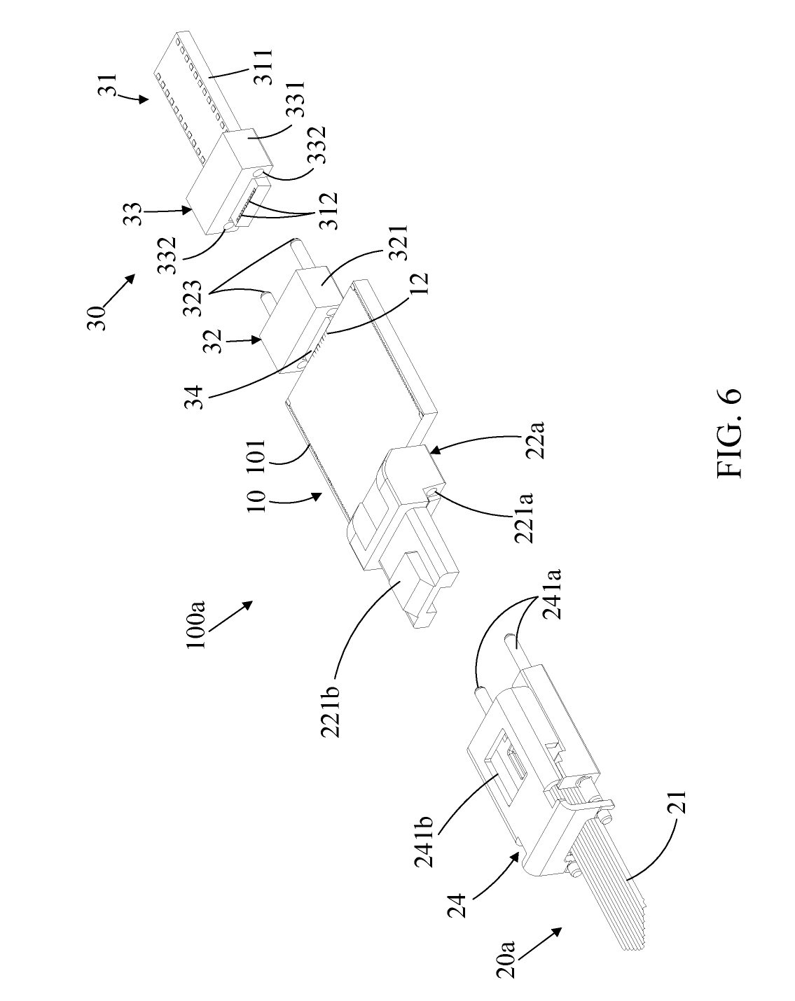

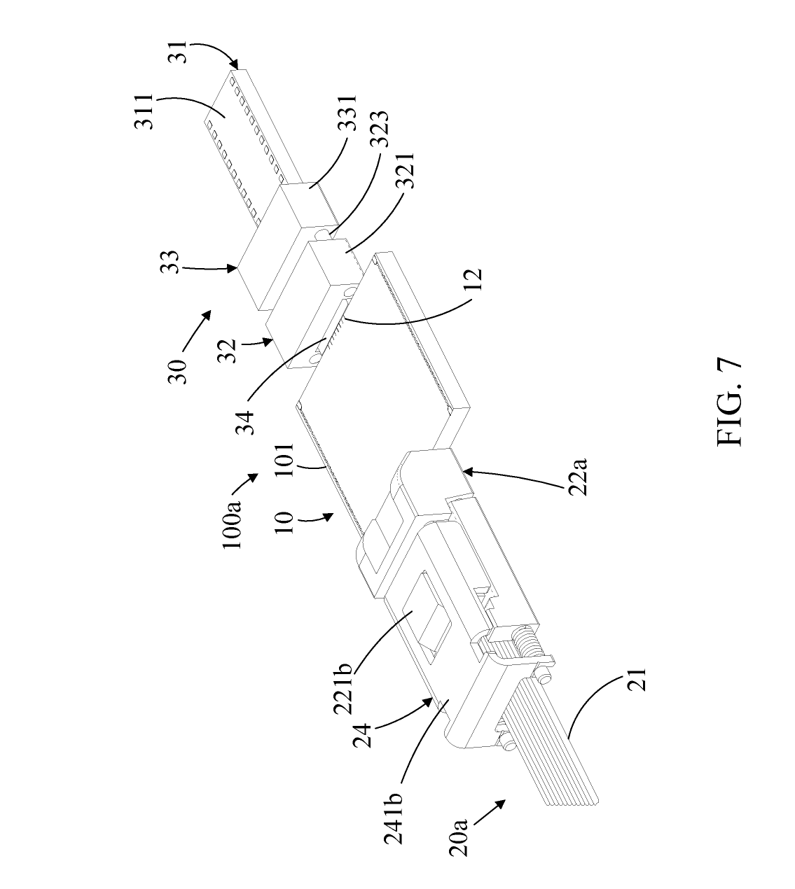

Referring to FIGS. 6 and 7, an optical connector assembly 100a for IC integration is illustrated according to a third embodiment of the present application, shown respectively in a disengaged state and an engaged state.

In the third embodiment, the fiber transmission module 20a includes two engagement components, namely a fiber fixed element 22a and a fiber detachable connector 24, which correspond to each other. The fiber fixed element 22a includes two mating portions 221a and 221b. The mating portion 221a is formed with a pair of holes, and the mating portion 221b is formed with an insertion piece having a protruding latching part.

The fiber detachable connector 24 includes two positioning portions 241a and 241b, respectively corresponding to and configured to engage with the two mating portions 221a and 221b. Specifically, the positioning portion 241a includes two insertion pins configured to engage with the mating portion 221a. The positioning portion 241b is a socket formed with a latching opening. Upon engagement, the protruding latching part of the mating portion 221b mates with the latching opening, thereby securing the fiber detachable connector 24 to the fiber fixed element 22a.

Notably, the number and configuration of the mating portions of the fiber fixed element 22a and the positioning portions of the fiber detachable connector 24 may vary according to design requirements. For example, in some embodiments, the fiber fixed element 22a may include a single mating portion, with the fiber detachable connector 24 including a corresponding single positioning portion. In other embodiments, multiple mating portions and positioning portions may be provided to enhance mechanical stability or alignment precision. The mating and alignment structures may employ various combinations of insertion pins, holes, latching features, or magnetic elements, depending on structural or optical coupling needs.

In the third embodiment, the combination of the mating portion 221b (i.e., the insertion piece) and the positioning portion 241b (i.e., the socket) of the fiber transmission module 20a may also be referred to as a reflow connector. Upon engagement of the fiber fixed element 22a with the integrated circuit module 10 and detachment of the fiber detachable connector 24 from the fiber fixed element 22a, at least one packaging or back-end process, such as reflow process, may be performed to solder the integrated circuit module 10 onto a substrate, such as a printed circuit board, or to another integrated circuit to form a 3D IC. Prior to the reflow process, the fiber part 21 is secured within the fiber detachable connector 24, the fiber fixed element 22a is engaged with the fiber detachable connector 24, and an optical waveguide (not shown) is positioned on the fiber fixed element 22a through an active alignment process to align with the fiber part 21. The optical waveguide is then secured to the fiber fixed element 22a. The engaged fiber fixed element 22a and the fiber detachable connector 24 are positioned to align with the second optical interface 11 via an active alignment process. Once the coupler ports of the second optical interface 11, the optical waveguide, and the fiber part 21 are aligned, the fiber fixed element 22a is secured to the integrated circuit module 10. The fiber detachable connector 24 is then detached before the reflow process. This arrangement avoids exposing the fiber part 21 to high-temperature processing, thereby preventing thermal damage. Moreover, the mechanical connection between the fiber fixed element 22a and the integrated circuit module 10 may be enhanced by performing the reflow process after alignment.

Referring to FIG. 1 again, in some embodiments, the detachable laser transmission module 30 is also a reflow connector and provides similar function as the fiber transmission module 20a, and a detailed description thereof is omitted for brevity.

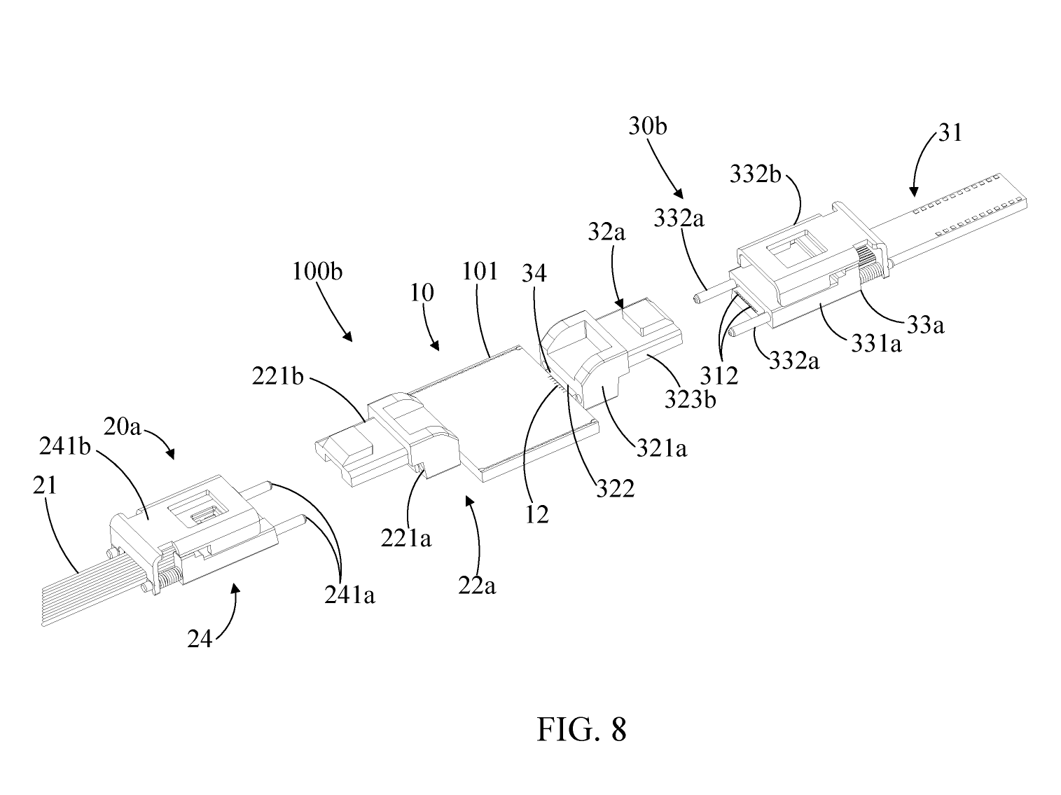

Referring to FIG. 8, FIG. 8 illustrates an optical connector assembly 100b for IC integration according to a fourth embodiment of the present application.

In the fourth embodiment, the fiber transmission module 20a is structurally identical to that disclosed in the third embodiment, and a detailed description thereof is omitted for brevity.

The detachable laser transmission module 30b similarly includes two corresponding engagement components, namely a laser fixed element 32a and a laser detachable connector 33a. The laser fixed element 32a includes two mating portions. One of the two mating portions includes a pair of holes (not shown) formed on the fixed housing 321a. The other one of the two mating portions, designated as 323b, is formed as an insertion piece having a protruding latching part. The laser detachable connector 33a includes two positioning portions 332a and 332b, respectively corresponding to and configured to engage with the two mating portions of the laser fixed element 32a. Specifically, the positioning portion 332a includes a pair of insertion pins configured to be inserted into the holes. The positioning portion 332b is a socket formed with a latching opening. During engagement, the protruding latching part of the mating portions 323b is secured within the latching opening, while the mating portion 323b is inserted into the socket, thereby achieving stable mechanical and optical alignment between the detachable laser transmission module 30b and the integrated circuit module 10.

It should be noted that the number and configuration of the mating portions of the laser fixed element 32a and the positioning portions of the laser detachable connector 33a may be flexibly adjusted based on system design constraints. In some embodiments, a single pair of corresponding mating and positioning portions may be provided to achieve basic engagement. In other embodiments, multiple pairs of such corresponding structures may be incorporated to enhance mechanical stability and alignment accuracy.

In one embodiment, the guiding element 34 is positioned within the fixed housing 321a of the laser fixed element 32a and is optically aligned with the laser array 312 by an active aligned process.

In the fourth embodiment, the fiber transmission module 20a and the combination of the mating portion 323b (i.e., the insertion piece) and the positioning portion 332b (i.e., the socket) of the detachable laser transmission module 30b are referred to as reflow connectors. After the fiber fixed element 22a and the laser fixed element 32a are secured to the integrated circuit module 10, and the fiber detachable connector 24 and the laser detachable connector 33a are respectively detached, at least one packaging or back-end process, such as reflow process, is performed to solder the integrated circuit module 10 onto a substrate or printed circuit board, or to solder another IC to the integrated circuit module 10.

The present application provides at least the following beneficial effects. An active alignment process is performed between the laser array 312 and the integrated circuit module 10, and between the fiber part 21 and the integrated circuit module 10, prior to engagement, enabling array-level coupling and sub-micron optical alignment precision. This configuration reduces labor costs and insertion loss, and enhances optical performance. This configuration also enables reusability by allowing an alternative laser device to align with the first optical interface 12, and an alternative fiber optical device to align with the second optical interface 11, through respective active alignment processes. In addition, since the laser array 312 is a one-piece array formed using epitaxial growth and externally positioned from the integrated circuit module 10, thermal interference with the integrated circuit module 10 is minimized, and integration flexibility and fabrication yield are improved. This arrangement further facilitates compatibility with semiconductor manufacturing workflows.

While the present application has been described with reference to certain presently preferred embodiments, the foregoing description is intended for illustrative purposes only and should not be construed as limiting. Various modifications, alternatives, and equivalents may be made by those skilled in the art without departing from the scope of the present application.

It should be noted that while the combination of components described herein are preferred for forming the disclosed embodiments, such combinations should not be construed as limiting the scope of the present application. The disclosed components may be combined or arranged in various other ways beyond those specifically illustrated and described.

What is claimed is:

1. An optical connector assembly for IC integration, comprising:
an integrated circuit module comprising an integrated circuit; and
a detachable laser transmission module configured to optically couple to the integrated circuit module.

2. The optical connector assembly for IC integration according to claim 1, wherein the detachable laser transmission module comprises:
a laser fixed element configured to be secured to the integrated circuit module; and
a laser detachable connector detachably engaged with the laser fixed element and configured to hold a laser unit.

3. The optical connector assembly for IC integration according to claim 2, wherein the laser unit includes a substrate and a laser array formed along an edge of the substrate, the laser array being composed of a plurality of laser emitters to form a one-piece laser array.

4. The optical connector assembly for IC integration according to claim 2, wherein the detachable laser transmission module further comprises a guiding element positioned in the laser fixed element, the guiding element being configured to be fixed in the laser fixed element after active alignment with the laser unit.

5. The optical connector assembly for IC integration according to claim 4, wherein the laser fixed element is configured to be secured to the integrated circuit module after the guiding element, the laser unit, and the integrated circuit are actively aligned with one another.

6. The optical connector assembly for IC integration according to claim 4, wherein the laser fixed element includes:
a fixed housing disposed adjacent to the integrated circuit module;
an installation slot recessed in the fixed housing and configured to accommodate the guiding element; and
at least one mating portion; and
wherein the laser detachable connector includes:
a main body; and
at least one positioning portion detachably engaged with the mating portion.

7. The optical connector assembly for IC integration according to claim 4, wherein the integrated circuit module further comprises a first optical interface disposed on a side of the integrated circuit, at least one internal feedback loop is formed between the guiding element and the first optical interface upon engagement of the detachable laser transmission module and the integrated circuit module, and the at least one internal feedback loop is configured to receive an optical signal emitted from the laser unit.

8. The optical connector assembly for IC integration according to claim 2, wherein the detachable laser transmission module comprises two guiding elements configured to mutually align with each other, one of the two guiding elements being positioned within the laser fixed element, and the other one of the two guiding elements being positioned at the laser detachable connector and optically aligned to the laser unit.

9. The optical connector assembly for IC integration according to claim 1, wherein the integrated circuit module further comprises a first optical interface and a second optical interface disposed on a side of the integrated circuit and the detachable laser transmission module is configured to optically couple to the first optical interface.

10. The optical connector assembly for IC integration according to claim 9, further comprising a fiber transmission module configured to optically couple to the integrated circuit module, wherein the fiber transmission module comprises:
a fiber part;
a fiber fixed element secured to the integrated circuit module; and
a cover configured to hold and secure the fiber part to the fiber fixed element;
wherein the fiber part includes multiple optical fibers housed between the fiber fixed element and the cover and optically coupled to the second optical interface.

11. The optical connector assembly for IC integration according to claim 9, further comprising a fiber transmission module configured to optically couple to the integrated circuit module, wherein the fiber transmission module comprises:
a fiber part;
a fiber fixed element secured to the integrated circuit module and including at least one mating portion; and
a fiber detachable connector detachably engaged with the fiber fixed element and including at least one positioning portion respectively corresponding to and configured to engage with the mating portion,
wherein the fiber part includes multiple optical fibers being held by the fiber detachable connector and optically coupled to the second optical interface.

12. A detachable laser transmission module, configured to optically couple to an integrated circuit module and comprising:
a laser fixed element configured to be secured to the integrated circuit module; and
a laser detachable connector detachably engaged with the laser fixed element and configured to hold a laser unit.

13. The detachable laser transmission module according to claim 12, wherein the laser unit includes a substrate and a laser array formed along an edge of the substrate, the laser array being composed of a plurality of laser emitters to form a one-piece laser array.

14. The detachable laser transmission module according to claim 12, further comprising a guiding element positioned in the laser fixed element, wherein the guiding element is configured to be fixed in the laser fixed element after active alignment with the laser unit.

15. The detachable laser transmission module according to claim 14, wherein the laser fixed element is configured to be secured to the integrated circuit module after the guiding element, the laser unit, and the integrated circuit module are actively aligned with one another.

16. The detachable laser transmission module according to claim 14, wherein the laser fixed element includes:
a fixed housing disposed adjacent to the integrated circuit module;
an installation slot recessed in the fixed housing and configured to accommodate the guiding element; and
at least one mating portion;
wherein the laser detachable connector includes:
a main body; and
at least one positioning portion detachably engaged with the mating portion.

17. The detachable laser transmission module according to claim 14, wherein the integrated circuit module comprises an integrated circuit and a first optical interface disposed on a side of the integrated circuit, at least one internal feedback loop is formed between the guiding element and the first optical interface upon engagement of the laser transmission module and the integrated circuit module, and the at least one internal feedback loop is configured to receive an optical signal emitted from the laser unit.

18. The detachable laser transmission module according to claim 12, further comprising two guiding elements configured to mutually align with each other, one of the two guiding elements being positioned within the laser fixed element, and the other one of the two guiding elements being positioned at the laser detachable connector and optically aligned to the laser unit.
